(19) United States
(12) Patent Application Publication
(10) Pub. No.: US 2025/0170590 A1
(43) Pub. Date: May 29, 2025

(54) LOCKING MECHANISM FOR A LID OF A ROTOR OF A CENTRIFUGE AND CENTRIFUGE ROTOR

(71) Applicant: Thermo Electron LED GmbH, Osterode (DE)

(72) Inventor: Johann Naumann, Herzberg (DE)

(73) Assignee: Thermo Electron LED GmbH, Osterode (DE)

(21) Appl. No.: 18/841,912

(22) PCT Filed: Feb. 23, 2023
(86) PCT No.: PCT/EP2023/054570

§ 371 Date: Aug. 27, 2024

(30) Foreign Application Priority Data
Feb. 28, 2022 (EP) 22159129.0

(51) Int. Cl. B04B 7/06; B04B 7/08

(52) U.S. Cl. CPC B04B 7/06; B04B 7/08

(57) ABSTRACT

Locking mechanism for a lid of a rotor of a centrifuge, wherein the locking mechanism secures the lid on a rotor body in an axial direction, wherein the locking mechanism has at least one locking member slidable in a radial direction within a locking section of the lid, wherein the at least one locking member has a radially outward protruding locking portion in respect to the rotor body, wherein the locking portion is engageably connectable to a recess in the rotor body and rotor for a laboratory centrifuge with such a locking mechanism.

The invention pertains to a locking mechanism for a lid of a centrifuge rotor and a centrifuge rotor with a lid having such a locking mechanism.

The invention lies in the technical field of rotors for laboratory centrifuges and in particular in the field of locking mechanisms for lids of such rotors. An application for laboratory centrifuges is the separation of substances of higher and lesser density by the principle of sedimentation. Laboratory centrifuges therefore comprise rotors which have receptacles for sample containers. The sample containers are arranged in respect to a circumference of the rotor in most cases. The rotor of the centrifuge is rotationally driven around a central axis, thus exerting a centrifugal acceleration on the sample containers and the samples therein. In that way, it is possible to exert forces on the samples which are by several orders of magnitude higher than achievable under gravitational acceleration. In certain applications, rotors need to be sealed with lids, wherein the seal is required to be liquid, aerosol or gas tight in order to prevent injury of the user of the centrifuge before and after the centrifugation and in order to avoid contamination.

DE 10 2005 014 218 A1 shows a locking mechanism comprised in a sealing lid for a centrifuge rotor. This locking mechanism is intended to be operated with a single-hand operation and comprises a spring-loaded sliding mechanism which engages with a receiving section of the rotor in order to prevent the vertical movement of the lid. The locking mechanism slides in a radial direction in reference to the rotor. The inner volume of the rotor is sealed with circular sealing lips on the inner through hole of the rotor near the hub and on the outer circumference. The locking mechanism comprises a single slider which is single-sided spring-loaded. The handle of the locking mechanism has two halves, which are held together by a cylindrical portion of the lid and a securing ring. The locking element (sliding element) engages with its cut-out with a groove in a pin and the pin is held in a loose axial fit in the rotor. The sliding element is slidable in a radial direction (in relation to the rotor) and is actuated against a compression spring. The knob which is manipulated by the user lies radially outside one of the halves.

The locking mechanism for lids of centrifuge rotors is easy and convenient to use due to the one-hand operation. However, the single-sided operation of the locking mechanism via the locking and sliding element bears the risk that the locking mechanism is accidentally disengaged, wherein the lid may also be accidentally lifted from the rotor body. The asymmetric design of the locking mechanism and the engagement with the axially loose-fit pin may additionally lead to an unintended breach of the sealing between the lid and the rotor body during manipulation of the locking mechanism and/or the knob of the lid. Thus, uncontrolled release of gases, aerosols and/or liquids may happen and potentially harm the operator of the centrifuge and/or lead to contaminations.

The problem to be solved is to improve the operational safety of centrifuge rotors with lids while maintaining the usability of the rotor and especially the locking mechanism.

The invention described herein is associated with an improved locking mechanism according to claim 1 and, according to claim 15, with an improved rotor comprising a lid with such a locking mechanism.

The invention pertains to a locking mechanism for a lid of a rotor of a centrifuge, wherein the locking mechanism secures the lid on a rotor body in an axial direction, wherein the locking mechanism has at least one locking member slidable in a radial direction within a locking section of the lid, wherein the invention foresees that the at least one locking member has a radially outward protruding locking portion in respect to the rotor body, wherein the locking portion is engageably connectable to a recess in the rotor body.

By having a radially outward protruding locking portion in respect to the rotor body, wherein the locking portion engages with the rotor body, a seal can be established between the lid and the rotor body. The locking mechanism engaging with the rotor body itself serves for a sealing which is insensitive to disruptions during operation of the centrifuge or during manipulation of the rotor and/or the lid. A seal is preferably embodied by a sealing lip attached to the rotor body or the lid on the inner circumference in a hub area of the rotor and the outer circumference of the rotor. In a preferred embodiment, the locking portion may have a chamfer while the recess in the rotor body may also have a corresponding chamfer, wherein the chamfers act in combination during the engagement of the locking mechanism so that the lid is axially moved against the rotor body and the seal between the lid and the rotor body gets compressed. In a further aspect, the locking mechanism may have fixed hook element which is diametrally opposed to the locking element and may have a similar shape as the locking element. The hook element may be brought into an engageable connection with the rotor body by tilting the lid and the locking mechanism in respect to the rotational axis and engaging the hook element with a recess in the rotor body. The locking member may be brought into engagement with the rotor body after tilting the lid back into a normal position. According to a further aspect of the invention, the locking member may have main body between a operating section, which is foreseen to be manipulated by an operator of the locking mechanism, and the locking portion. The main body has essentially the shape of an U-shaped half shell, wherein the locking member has a C-chape in a side view, wherein the operating section and the locking portion protrude in the same radial direction from the main body.

According to a further aspect of the invention, the locking mechanism has two opposing locking members slidable in a radial direction in reference to the rotor body. By having two slidable locking members, wherein each locking member engageably connects to the rotor body, it will be necessary to disengage both locking members to remove the lid. Thus, the safety against unwanted disengagement of the lid and thus the operational safety of the lid-sealed rotor is improved.

According to another aspect of the invention, it is foreseen that the two locking members of the locking mechanism are symmetrical or mirror symmetrical. The symmetry of the locking mechanisms contributes to an improved concentricity when the rotor is rotationally driven, wherein the distribution of masses in respect to the radial position is in essence the same on a diametral line. Thus, higher speeds of rotation may be obtained without provoking vibration or rumble caused by an uneven mass distribution of the locking mechanism. This contributes to the overall performance of the centrifuge, as well as to the operational safety since vibrations may cause intermittent or permanent leakages between the lid and the rotor body and therefore unwanted release of gases, aerosols, or liquids.

According to one further aspect of the invention, the at least one locking member is disengaged from the rotor body in a radially inward position in respect to the rotor body and the at least one locking member is engaged with the rotor body in a radially outward position in respect to the rotor body. In that way, it is possible to disengage the locking mechanism by compression of the locking member or the locking members in a radially inward movement. This contributes to the ease of use of the locking mechanism and allows for a single-handed operation, especially when the locking mechanism is arranged centrally in respect to the rotor body.

According to a further aspect, it is foreseen that the at least one locking member of the locking element engages with a hub section of the rotor. The hub section of the rotor is preferably a central annulus within the rotor body, where engagement means engage the rotor with the drive mechanism of the centrifuge. The hub section is therefore embodied as a rigid part of the rotor body, which contributes to a rigid connection of the locking member with the rotor body and thus a reliable locking of the lid to the rotor body. Additionally, the central arrangement in a preferably in respect to the rotor body centrally placed hub section allows for a single-handed operation with the advantages as stated above.

In a further aspect of the invention, it is foreseen that the at least one locking member engages with a ring groove in the hub section of the rotor. In that way, there is no predetermined angular arrangement between the lid and the rotor body, as the locking member(s) may engage at any circumferential position of the ring groove. However, it may also be foreseen that the ring groove is omitted for the benefit of circumferentially oriented receptacles along the inner circumference of the hub section. This would allow for a defined angular arrangement between the lid and the rotor body, wherein there may be a single or more angular arrangements possible through a corresponding circumferential distribution of the receptacles.

According to another aspect of the invention it is foreseen that the at least one locking member is spring loaded. In a further embodiment, the at least one locking member is spring loaded against the engagement direction. The direction of engagement is the direction in which the locking member is moving in order to engage with the rotor body. In that way, the user of the locking mechanism has to overcome the spring force to disengage the locking mechanism from the rotor body. In order to achieve a spring-loading, a compression spring is foreseen in a preferred embodiment.

After a further aspect of the invention, it is foreseen that the at least one locking member is spring loaded against the locking section. The locking section of the lid is preferably a rigid structure housing the locking mechanism and in particular the locking member(s). The locking section is preferably not moving against the lid and/or the rotor and may preferably be an integral part of the lid. So, the spring loading against the locking section is advantageous since the locking section may receive the forces exerted by the user in order to disengage the locking mechanism. The forces may be adjusted by specification of the spring-loading element. In that way, the locking mechanism may be designed to be easy to operate by choosing a soft spring loading or harder to operate by choosing a harder spring loading. Depending on the application either option may be desirable, e.g. to enhance the security of the sealing or to enhance the ease of use.

According to another aspect of the invention, the locking mechanism may have a first locking member which is spring loaded against a second locking member, wherein the first locking member and the second locking member are slidable in a radial direction in reference to the rotor body, respectively. Preferably, the locking members are spring loaded against the respective engagement direction. In that way, the double engagement of the locking members enhances the security of the attachment of the lid to the rotor body. Especially, the locking members both need to be pressed against the spring loading to disengage the respective locking member from the rotor body. If only one locking member is pressed, the spring loading of the second locking member would not be released. In fact, the second locking member would be pressed further in the engagement direction by the force exerted by the first, disengaged locking member via the spring loading element (e.g. a compression spring). In that way, the locking mechanism according to this aspect of the invention foresees a mechanically redundant securing mechanism for the lock engagement between the lid and the rotor body.

According to another aspect of the invention it is accordingly foreseen, that the locking mechanism has at least one spring loaded locking member, loaded by a compression spring, wherein the compression spring oriented in a radial direction in reference to the rotor body. In alternate embodiments, the spring loading could also be realized by a compliant mechanism, which may e.g. comprise a part made of an elastic material such as rubber, or another type of spring such as a torsional spring concentrically oriented to the hub section of the rotor body.

A further aspect of the invention foresees that the locking mechanism is a central knob or handle of the lid. In that way, the lid may be conveniently removed after disengagement of the locking members without the need of further manipulation. The handle is preferably a symmetric, two-piece assembly.

Another aspect of the invention foresees that the locking member or the locking members of the locking mechanism having protrusions engaging with radially oriented grooves in the locking section. Alternatively, it may be foreseen that the locking member or the locking members of the locking mechanism have grooves into which radially oriented protrusions in the locking section of the handle engage. In that way, it is possible to slide the respective locking member in the radial direction and in particular in or against the engagement direction for engagement or disengagement from the rotor body. The aforementioned groove/protrusion guiding is especially advantageous in combination with spring loading and in particular when compression springs are employed. The guiding hinders the locking members from jamming in the locking mechanism.

According to a further aspect of the locking mechanism, it is foreseen that at least one locking member has a mandrel, wherein the mandrel engages between a sealing lip of the lid and the rotor body during or after the locking member is disengaged from the rotor body. According to a further aspect of the invention, the mandrel is oriented in the engagement direction of the respective locking member wherein the locking portion of the locking member is oriented against the engagement direction of the locking member. In a further development, the mandrel may be wedge-shaped and engage with the sealing lip before the locking member is disengaged from the rotor body. When engaged with the sealing lip, the mandrel equalizes pressure differences between the inner volume of the rotor body enclosed by the lid and the outer volume surrounding the rotor body with the lid. A positive pressure difference in respect to the inner volume of rotor body may lead to a suction effect, wherein the sealed lid may not be lifted from the rotor body without the application of a substantial amount of force. This is advantageously avoided by a pressure equalisation. Thus, accidents caused by an uncontrolled and abrupt lifting of the lid may be avoided. A negative pressure difference in respect to the inner volume (the pressure within the rotor is higher than the ambient pressure) may lead to abrupt degassing of the rotor and potentially also the samples. The pressure equalisation by means of the mandrels and especially if they are arranged in the lead as described above, the pressure may be controllably equalized by operation of the locking members.

According to another aspect, the locking mechanism has a central axial clearance concentrically oriented to a spinning axis of the rotor. This allows for an axially oriented second locking mechanism for locking the rotor to the driving mechanism of the centrifuge. The second locking mechanism is preferably operated axially with a spring-loaded push mechanism to engage the rotor to the driving mechanism radially and/or axially.

The invention also pertains to a rotor for a laboratory centrifuge comprising a cylindrical rotor body with a closed base, an outer shell and an opening, wherein the opening is sealed with a detachable sealing lid, wherein the invention foresees that the detachable sealing lid has a locking mechanism according to any one of the preceding claims. The above-mentioned advantages also apply for the detachable sealing lid with the locking mechanism according to the invention.

The invention will now be described in relation to the following non-limiting figures. Further advantages of the disclosure are apparent by reference to the detailed description when considered in conjunction with the figures in which:

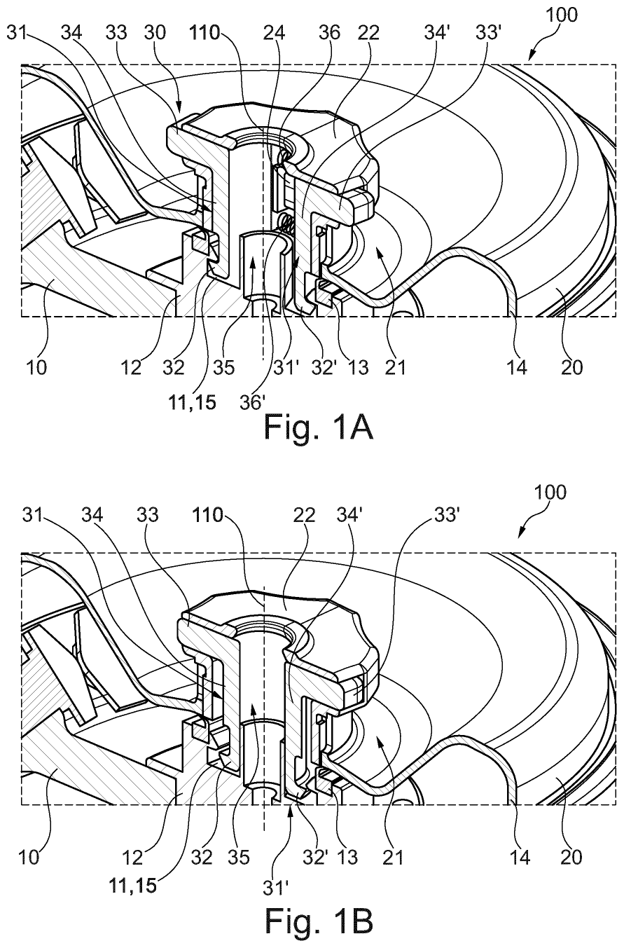

FIG. 1A shows a sectional, perspective view of the locking mechanism comprised in a lid for a rotor body, wherein the locking mechanism is displayed in an engaged position;

FIG. 1B shows a sectional, perspective view of the locking mechanism comprised in a lid for a rotor body, wherein the locking mechanism is displayed in a disengaged position;

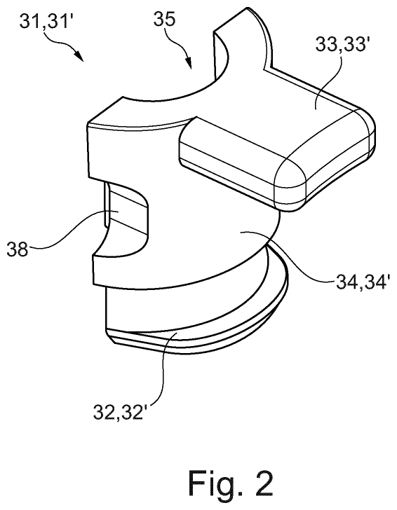

FIG. 2 shows a schematic, perspective, and isolated view of a locking member; and

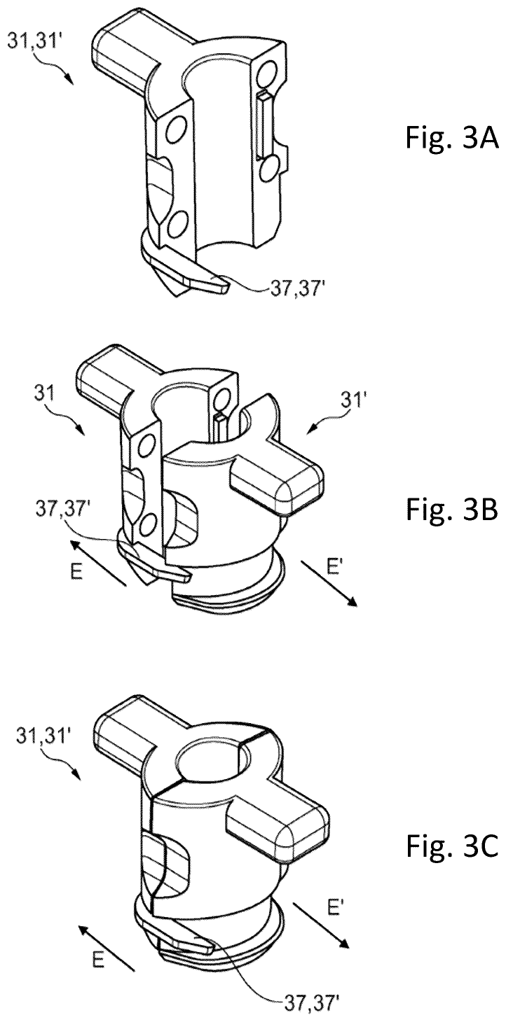

FIG. 3 shows schematic, perspective, and isolated views of a locking members with mandrels.

FIG. 1A shows a sectional, perspective view of the locking mechanism 30 comprised in a lid 20 for a rotor body 10, wherein the locking mechanism 30 is displayed in an engaged position. The rotor 100 may be a rotor 100 of a laboratory centrifuge (not displayed). The lid 20 and the rotor body 10 are concentrically arranged about a rotation axis 110 of the rotor 100. The rotor body 10 may have a cylindrical or frustoconical shape with an open hub section 12 in its centre area and the lid 20 may seal the rotor body 10. The lid 20 may be made of a plastic material and may allow for a radial and/or axial flex. Between the rotor body 10 and the lid 20, there is an annular inner seal 13 at the hub section 12 and another annular outer seal 14 at the outer periphery of the rotor body 10. The inner seal 13 and outer seal 14 may be embodied as a separate sealing lip or may be embodied as radial and/or axial protrusions of the lid.

The rotor body 10 has a central hub 12 section. The lid 20 has a locking section 21, which is implemented in this embodiment as a handle 22, wherein the handle is preferably symmetric and a two-piece arrangement. The handle 22 comprises the locking mechanism 30. According to this embodiment, the locking mechanism 30 has two locking members 31, 31′, which are slidably arranged within the handle 22. The locking members 31, 31′are slidable in a radial direction R in respect to the rotor body 10. The locking mechanism 30 secures the lid on a rotor body 10 in an axial direction A. In respect to the rotor body 10, the locking members 31, 31′ have radially outward protruding locking portions 32, 32′. The respective locking portion 32, 32′ engages with a recess 11 in the hub section 12 of the rotor body 10. In this embodiment, the recess 11 is embodied as radially outwardly protruding ring groove 15 into which the radially outward protruding locking portions 32, 32′ of the locking members 31, 31′ slide for their engagement. The locking members 31, 31′ also comprise operating sections 33, 33′, which are slidable in the radial direction with their respective locking member 31, 31′. The operating sections 33, 33′ are attached to the locking member 31, 31′ and the locking members 31, 31′ are preferably embodied as a single piece, respectively, comprising the locking portions 32, 32′ and the operating sections 33, 33′. The operating sections 33, 33′ slide within the handle 22 and have an exposed part in the engaged state which is operable by the operator of the locking mechanism 30 to disengage the locking mechanism 30. The locking members 31, 31′ have a main body 34, 34′ between the respective operating section 33, 33′ and the locking portion 32, 32′. The main body 34, 34′ has essentially the shape of an U-shaped half shell, wherein there is an axial, essentially cylindrical clearance 35 between the locking members 31, 31′ in the engaged state (FIG. 1A) and in the disengaged state (FIG. 1B). The seal between the rotor body 10 and the lid 20 is established in an engaged state of the locking mechanism 30, wherein the lid is axially secured by the engagement of the locking portions 32, 32′ with the recess 11 in the hub section 12 of the rotor body 10.

In order to transfer the locking mechanism 30 from an engaged state (cf. FIG. 1A) to a disengaged state (cf. FIG. 1B), the operator needs to push the operating sections 32, 32′ radially inwards, which leads to a disengagement of the locking portions 32, 32′ from the hub section 12 of the rotor body 10. The way of radial travel of the respective locking member 31, 31′ amounts to at least the axial overlap of the locking portion 32, 32′ with the hub section 12 of the rotor body 10 in an engaged state. The locking members 31, 31′ of this embodiment are symmetrical. The locking members 31, 31′ are spring loaded against each other by compression springs 36, 36′ which are oriented parallel to the radial sliding direction R, so that the axial cylindrical clearance 35 is not obstructed by the compression springs 36, 36′. This embodiment foresees two compression springs 36, 36′ on two sides of the locking mechanism, wherein the two compression springs 36, 36′ are oriented in respect to the rotational axis 110 of the rotor 100 axially on top of each other. For an improved radial and axial guidance, this embodiment foresees a linear protrusion 24 within the handle 22 and a linear groove 38 within the locking members 31, 31′, wherein the locking members 31, 31′ glide with their respective groove 38 on the protrusion 24 of the handle 22.

FIG. 1B shows a sectional, perspective view of the locking mechanism 30 of FIG. 1A in a disengaged position.

It can be seen that the locking members 31, 31′ are in a radially inwards position in respect to the rotor body 10, wherein the locking members 31, 31′ did slide with their on the protrusions 24 of the handle 22 against the force of the compression springs. The operating sections 33, 33′ are in a retracted state within the handle 22 and the locking portions 32, 32′ of the locking members 31, 31′ are in a disengaged position from the ring groove 15 of the hub section 12 of the rotor body 10. In that way, the lid 20 is free to be removed from the rotor body 10 in an axial direction A.

FIG. 2 shows a schematic, perspective, and isolated view of a locking member 31, 31′. As already displayed in respect to FIG. 1, the locking member 31, 31′ is a single piece assembly comprising the operating section 33, 33′ on a top end of the locking member 31, 31′. A main body 34, 34′ connects the operating section 33, 33′ with the locking portion 32, 32′ of the locking member 31, 31′. The main body 34, 34′ has essentially the shape of a U-shaped half-shell, wherein the locking portion 32, 32′ and the operating section 33, 33′ protrude on the convex lateral surface of the half shell. Within the convex lateral surface, the respective locking member 31, 31′ has a groove 38 oriented in the radial direction R.

FIG. 3 shows schematic, perspective, and isolated views of an embodiment of locking members 31, 31′ with a mandrel 37, 37′ in isolation and a disengaged and an engaged state. The locking members 31, 31′ may be employed in the locking mechanism 30 according to FIG. 1A and FIG. 1B. The locking members 31, 31′ have essentially the same features as described above, wherein a locking member 31, 31′ of the locking mechanism may be equipped with an additional mandrel 37, 37′extending in the radial direction and oriented in the engagement direction E, E′ of the respective locking member 31, 31′. In case of two symmetrical locking members 31, 31′, each locking member 31, 31′ may be equipped with a mandrel. Alternatively, the embodiment foresees that at least one locking member 31 is equipped with a mandrel 37. When the locking members 31, 31′ are brought into a disengaged state by pressing the operating section 33, 33′ of a locking member 31, 31′ against its respective engagement direction E, E′, the mandrel 37, 37′ breaks the annular inner seal 13 in order to equalize pressure differences between the inner volume of the rotor body 10 and the environment.

It will be appreciated that the present disclosure is not limited to the embodiments described above and that modifications and variations on the embodiments described above will be readily apparent to the skilled person.

It is for example possible to foresee another type of spring loading mechanism to achieve the spring loading of the respective locking member 31, 31′ in the engagement E, E′ direction E, E′. The spring loading could e.g. be realized by a torsional spring or a compliant mechanism made e.g. out of an elastic, rubber part, within the handle without obstructing the central axial clearance 35 of the locking mechanism 30. The axial clearance 35 may receive an independent locking mechanism 30 for attaching the rotor body 10 to a driving mechanism of the laboratory centrifuge.

Features of the embodiments described above may be combined in any suitable combination with features of other embodiments described above as would be readily apparent to the skilled person and the specific combinations of features described in the above embodiments should not be understood to be limiting.

### LIST OF REFERENCE SIGNS

10 rotor body
11 recess
12 hub section
13 annular inner seal
14 annular outer seal
15 ring groove
20 lid
21 locking section
22 handle
24 protrusion
30 locking mechanism
31, 31′ locking member
32, 32′ locking portion
33, 33′ operating section
34, 34′ main body
35 axial clearance
36, 36′ compression spring
37, 37′ mandrel
38 groove
100 rotor
110 rotation axis
A axial direction
R radial direction
E, E′ engagement direction

1. A locking mechanism for a lid of a rotor of a centrifuge, wherein the locking mechanism secures the lid on a rotor body in an axial direction, wherein the locking mechanism has at least one locking member slidable in a radial direction within a locking section of the lid, characterized in that the at least one locking member has a radially outward protruding locking portion in respect to the rotor body, wherein the locking portion is engageably connectable to a recess in the rotor body.

2. The locking mechanism according to claim 1, characterized in that the locking mechanism has two opposing locking members slidable in a radial direction in reference to the rotor body.

3. The locking mechanism according to claim 2, characterized in that the two opposing locking members are symmetrical or mirror symmetrical.

4. The locking mechanism according to claim 1, characterized in that the at least one locking member is disengaged from the rotor body in a radially inward position in respect to the rotor body and the at least one locking member is engaged with the rotor body in a radially outward position in respect to the rotor body.

5. The locking mechanism according to to claim 1, characterized in that the at least one locking member engages with a hub section of the rotor.

6. The locking mechanism according to claim 5, characterized in that the at least one locking member engages with a ring groove in the hub section of the rotor.

7. The locking mechanism according to claim 1, characterized in that the at least one locking member is spring loaded.

8. The locking mechanism according to claim 7, characterized in that the at least one locking member is spring loaded against the locking section.

9. The locking mechanism according to claim 7, characterized in that a first locking member is spring loaded against a second locking member, wherein the first locking member and the second locking member are slidable in a radial direction in reference to the rotor body, respectively.

10. The locking mechanism according to claim 7, characterized in that the at least one locking member is spring loaded by a compression spring oriented in a radial direction in reference to the rotor body.

11. The locking mechanism according to claim 1, characterized in that the locking section is a central knob or handle of the lid.

12. The locking mechanism according to claim 1, wherein the at least one locking member has at least one protrusion engaging with at least one radially oriented groove in the locking section or vice versa.

13. The locking mechanism according to claim 1, characterized in that at least one locking member has a mandrel, wherein the mandrel engages between a seal between the lid and the rotor body during or after the locking member is disengaged from the rotor body.

14. The locking mechanism according to claim 1, wherein the locking mechanism has a central axial clearance concentrically oriented to a spinning axis of the rotor.

15. A rotor for a laboratory centrifuge comprising a cylindrical rotor body with a closed base, an outer shell and an opening, wherein the opening is sealed with a detachable sealing lid, characterized in that the detachable sealing lid has a locking mechanism according to claim 1.

16. A rotor for a laboratory centrifuge comprising a cylindrical rotor body with a closed base, an outer shell and an opening, wherein the opening is sealed with a detachable sealing lid, characterized in that the detachable sealing lid has a locking mechanism according to claim 4.

17. The locking mechanism according to claim 8, characterized in that the at least one locking member is spring loaded by a compression spring oriented in a radial direction in reference to the rotor body.

18. The locking mechanism according to claim 1, wherein the at least one locking member has at least one protrusion engaging with at least one radially oriented groove in the locking section or vice versa.

19. The locking mechanism according to claim 2, characterized in that at least one locking member has a mandrel, wherein the mandrel engages between a seal between the lid and the rotor body-during or after the locking member is disengaged from the rotor body.

20. The locking mechanism according to claim 3, characterized in that at least one locking member has a mandrel, wherein the mandrel engages between a seal between the lid and the rotor body-during or after the locking member is disengaged from the rotor body.
